(19) United States
(12) Patent Application Publication
(10) Pub. No.: US 2004/0104542 A1
(43) Pub. Date: Jun. 3, 2004

(54) Vehicle inner belt molding and sealing structure using the same

(75) Inventors: Yohsuke Kobayashi, Aichi (JP); Hakurei Watanabe, Saitama (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: TOKAI KOGYO CO., LTD., Obu-city (JP); HONDA GIKEN KOGYO KABUSHIKI KAISHA, Tokyo (JP)

(21) Appl. No.: 10/654,892

(22) Filed: Sep. 5, 2003

(30) Foreign Application Priority Data
Sep. 6, 2002 (JP) 2002-260913

(51) Int. Cl. F16J 15/02

(52) U.S. Cl. 277/640

(57) ABSTRACT

A vehicle inner belt molding to be fitted along an interior of an opening edge of an elevating window in a vehicle wherein the vehicle has a door inner panel and a trim board being attached to the door inner panel and having a downward flange portion protruding from a position interior of an outer end of the trim board. The vehicle inner belt includes: a fitting portion to be attached to a vehicle body; and a sealing lip formed integrally with an exterior side of the fitting portion to be in elastic contact with an inner surface of a window pane of the elevating window. The fitting portion has an upward opening groove fittable with the downward flange portion.

### BACKGROUND OF THE INVENTION

1. Field of the Invention

The present invention relates to a vehicle inner belt molding fitted along a window opening edge of a door inner panel of a door having an elevating windowpane, which moves vertically in the inside of the opening door or the non-opening door having the door outer panel and the door inner panel of the vehicle, and a sealing structure using the same. This vehicle inner belt molding (in some case, referred simply to as the “belt molding” hereinafter) is used to prevent water and dust from entering into the inside of the car from the outside of the car, by covering a clearance between the window opening edge of the door inner panel and the windowpane to shield it and also by elastically contact to the elevating windowpane to seal it.

2. Background Art

Many proposals on the belt molding and its fitting structure have already been made. Then, as the recent belt molding structure, it is desired to reduce a clearance between the windowpane inner surface and the car-inner side door member from a viewpoint of improvement in the safety, i.e., such a peril must be avoided that fingers of an infant, etc. are caught in the elevating windowpane at the time of dropping the windowpane, and the ornamental property.

In order to satisfy the above request, if the belt molding is arranged to come close to the inner surface side of the windowpane, the clearance between them can be reduced, but the sealing lips of the belt molding also come close to the windowpane at the same time. Therefore, the sealing lips are brought strongly into contact with the inner surface of the windowpane, and thus a sliding resistance is increased when the windowpane moves up and down. In contrast, if a length of the sealing lips is shortened while maintaining the clearance still small in order to suppress an increase in the sliding resistance of the sealing lips against the inner surface of the windowpane, the sealing lips do not stably come into contact with the windowpane due to accumulated errors such as an assembling error of the windowpane, variation in a moving locus in the elevating motion of the windowpane, etc. Therefore, such a disadvantage is caused that the sealing performance is lowered.

### SUMMARY OF THE INVENTION

It is an object of the present invention to provide a belt molding capable of reducing a clearance between a windowpane inner surface and a car-inner side door member while maintaining the sealing performance without increase in a sliding resistance, and its fitting structure.

To achieve the object, the invention provides a vehicle inner belt molding to be fitted along an interior of an opening edge of an elevating window in a vehicle wherein the vehicle has a door inner panel and a trim board being attached to the door inner panel and having a downward flange portion protruding from a position interior of an outer end of the trim board. The vehicle inner belt molding includes: a fitting portion to be attached to a vehicle body; and a sealing lip formed integrally with an exterior side of the fitting portion to be in elastic contact with an inner surface of a window pane of the elevating window; wherein the fitting portion has an upward opening groove fittable with the downward flange portion.

According to the invention, the fitting portion of the inner belt molding is fitted to the trim board in the state that the downward flange portion that projects downward is inserted into the upward opening groove formed in the fitting portion. The downward flange portion projects from the position that is positioned slightly on the interior side than the outer side end of the trim board. Therefore, a clearance between the end edge of the trim board as the interior door member and the inner surface of the windowpane can be reduced without shortening a projection length of the sealing lips. As a result, it becomes possible to eliminate such a peril that the fingers of the infant, etc. are caught in the clearance and to improve the ornamental property. Further, a desired projection length of the sealing lips can be obtained while it is not necessary to shorten the projection length of the sealing lips. As a consequence, a margin of elastic deformation of the sealing lips with respect to the windowpane can be assured sufficiently. The sliding resistance is not increased during the operation of the elevating windowpane. The sealing performance is not reduced.

Preferably, the fitting portion includes an outer fitting portion having the upward opening groove and an inner fitting portion to be positioned interior of the outer fitting portion. The inner fitting portion has a downward opening groove for receiving an upper-edge flange portion of the door inner panel.

According to the invention, two different portions (fitted portions), i.e., the downward flange portion of the trim board constituting the interior door member and the upper-edge flange portion of the door inner panel, are received by the upward opening groove provided to the outer fitting portion and the downward opening groove provided to the inner fitting portion respectively. Therefore, even if a force of causing the belt molding itself to move vertically acts because of the sliding resistance to the sealing lips at the time of elevating the windowpane, movement of the belt molding can be prevented by any one of above two different fitted portions. As a result, the belt molding never comes off from the downward flange portion of the trim board. Also, since the belt molding is fitted to two different fitted portions that constitute the door member and are placed at a predetermined distance along the vehicle outward and inward directions, generation of a displacement of the fitted position of the belt molding in the vehicle outward and inward directions can be prevented in contrast to the case where the belt molding is fitted to only one fitted portion (the downward flange portion of the trim board). Therefore, rattle of the belt molding in the same direction can be prevented.

Preferably, the upward opening groove is provided with at least one gripping lip for gripping the downward flange portion to prevent the downward flange portion from coming-off.

According to the invention, the fitted portion constituting the door member is gripped by the gripping lip that is provided in the opening groove of the fitting portion of the belt molding. Therefore, the belt molding is hard to move with respect to the fitted portions in the vertical direction and the vehicle outward and inward directions. Therefore, both a coming-off of the belt molding from the fitted portions and rattle of the belt molding along the car inside-outside direction can be prevented.

Preferably, the downward opening groove is also provided with at least one gripping lip for gripping the upper-edge flange portion to prevent the upper-edge flange portion from coming-off.

According to the invention, since the gripping lip for gripping the upper-edge flange portion to prevent a coming-off is provided in the downward opening groove, the belt molding is hard to move with respect to the fitted portions in the vertical direction and the vehicle outward and inward directions.

Preferably, the vehicle inner belt molding further includes: a cloth pressing piece protruding upward from the exterior side of the fitting portion; wherein the cloth pressing piece presses an end portion of a cloth covering a surface of the trim board when the downward flange portion is fitted into the upward opening groove. According to the invention, when the trim board is fitted by inserting the downward flange portion of the trim board into the upward opening groove formed in the fitting portion of the belt molding or when the trim board is fitted by inserting the downward flange portion of the trim board into the upward opening groove formed in the fitting portion of the belt molding that is fixed to the upper-edge flange portion of the door inner panel, the end portion of the cloth that is fitted to the surface of the trim board is pressed by the cloth pressing piece being provided to the exterior side of the fitting portion to project upwardly, and thus the peeling-off of the end portion of the cloth from the surface of the trim board can be prevented. Preferably, the fitting portion has a positioning slit partially crossing therethrough; and the positioning slit is engageable with a positioning rib projecting downward from a back surface of the trim board.

According to the invention, since the belt molding is fixed to the trim board in the state that the belt molding is positioned along the longitudinal direction, relative displacement between them along the longitudinal direction of the car body can be prevented.

Preferably, a thickness of the positioning rib is smaller than a width of the positioning slits.

Since the width of the slits can be formed relatively wide when the slits are worked in the belt molding, the working of the slits can be facilitated. In contrast, since the positioning ribs can be formed thin when the trim board is molded by the injection molding, generation of the “sink mark” that is generated due to the formation of the positioning ribs on a surface of the trim board can be prevented. Also, since a thickness of the positioning ribs is smaller than a groove width of the slits, the assembling operation of the belt molding and the trim board can be made easy.

Preferably, the positioning slit includes at least two of positioning slits arranged at a predetermined interval in a longitudinal direction of the fitting portion; the positioning rib includes at least two of positioning ribs to be fitted into the positioning slits; and the two of positioning slits are formed so that the opposing surfaces of the two of positioning ribs are brought into contact with inner-side surfaces of the two of positioning slits when the two of positioning ribs are fitted into the two of positioning slits.

Preferably, the positioning slit includes at least two of positioning slits arranged at a predetermined interval in a longitudinal direction of the fitting portion; the positioning rib includes at least two of positioning slits to be fitted into the two of positioning slits; and the two of positioning slits are formed so that the outer-side surfaces of the two of positioning ribs are brought into contact with outer-side surfaces of the two of adjacent positioning slits when the two of positioning ribs are fitted into the two of positioning slits.

Preferably, the vehicle inner belt molding further includes: a core member embedded in the fitting portion in the longitudinal direction thereof, the core member made of a plate-like material having an expansion resistance and a rigidity both larger than those of the fitting portion; wherein the core member has a cross sectional shape substantially similar to that of at least a part of the fitting portion.

According to the invention, expansion and contraction of the belt molding can be prevented and also the strength of the fitting portion is increased. As a result, the fitting condition of the belt molding to the trim board can be stabilized.

Preferably, the fitting portion is made of thermoplastic elastomer material.

According to the invention, since the fitting portion made of thermoplastic elastomer material has an elasticity, “fit” of the fitting portion to the fitted portion is improved. Therefore, the fitting performance of the belt molding to the fitted portion can be enhanced.

Preferably, the sealing lip is made of a material which is capable of fusion bonding to the fitting portion and which is softer and more elastic than the fitting portion.

According to the invention, a proper elasticity is given to the sealing lip. As a result, the sealing lip comes into elastic-contact with the windowpane, and thus the sealing property between the windowpane and the sealing lips can be increased.

The invention provides a vehicle inner belt molding to be fitted along an interior side of an opening edge of the elevating window, the vehicle inner belt molding including a fitting portion to be attached to a vehicle body and a sealing lip formed integrally with an exterior side of the fitting portion to be in elastic contact with an inner surface of a window pane of the elevating window; and a trim board disposed inside of the elevating window, the trim board having a downward flange portion protruding from a position interior of an outer end thereof; wherein the fitting portion has an upward opening groove fittable with the downward flange portion; and the vehicle inner belt molding is attached to the trim board by inserting the downward flange portion into the upward opening groove.

Preferably, the fitting portion includes an outer fitting portion having the upward opening groove and an inner fitting portion to be positioned interior of the outer fitting portion; the outer fitting portion has a positioning slit partially crossing therethrough; the trim board has a positioning rib projecting downward from a back surface thereof; and the inner belt molding is attached to the downward flange portion while being positioned in a longitudinal direction by inserting the positioning rib into the positioning slits.

### BRIEF DESCRIPTION OF THE DRAWINGS

The present invention may be more readily described with reference to the accompanying drawings:

FIG. 1 is a side view showing a car right-side front door to which a belt molding according to the present invention is fitted when viewed from the inner side.

FIG. 2 is a cross sectional view showing the separated state of the belt molding and a trim board respectively.

FIG. 3 is a perspective view showing a part of upper end portions of the belt molding and the trim board on their rear end sides respectively.

FIG. 4 is an enlarged sectional view taken along an X₁—X₁ line in FIG. 1.

FIG. 5 is an enlarged sectional view taken along an X₂—X₂ line in FIG. 1.

FIG. 6 is a view showing mainly a relationship between a width of a positioning slit the belt molding and a thickness of a positioning rib of the trim board.

### DETAILED DESCRIPTION OF THE PREFERRED EMBODIMENTS

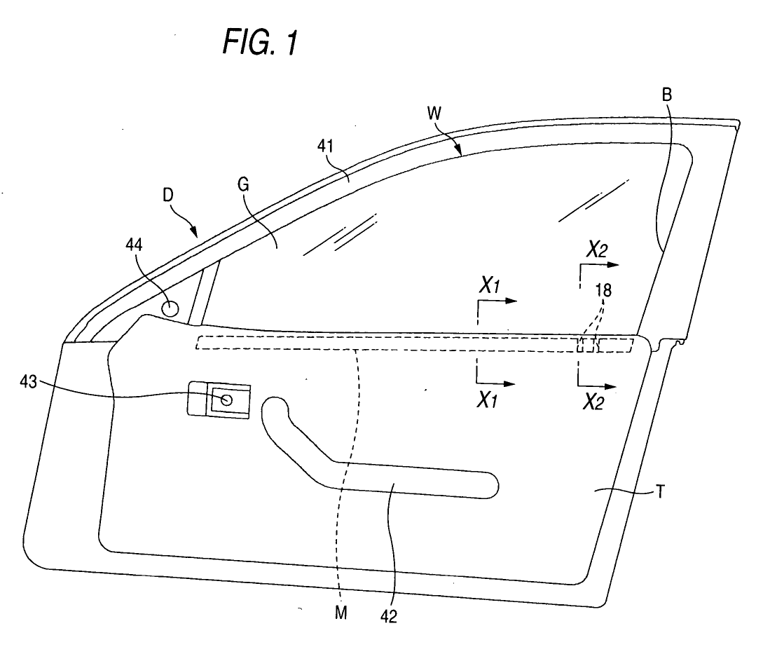

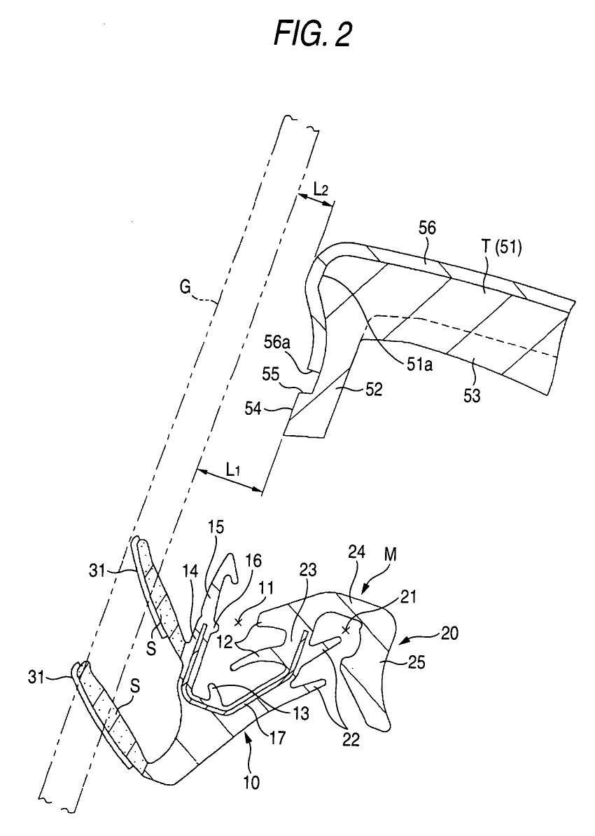

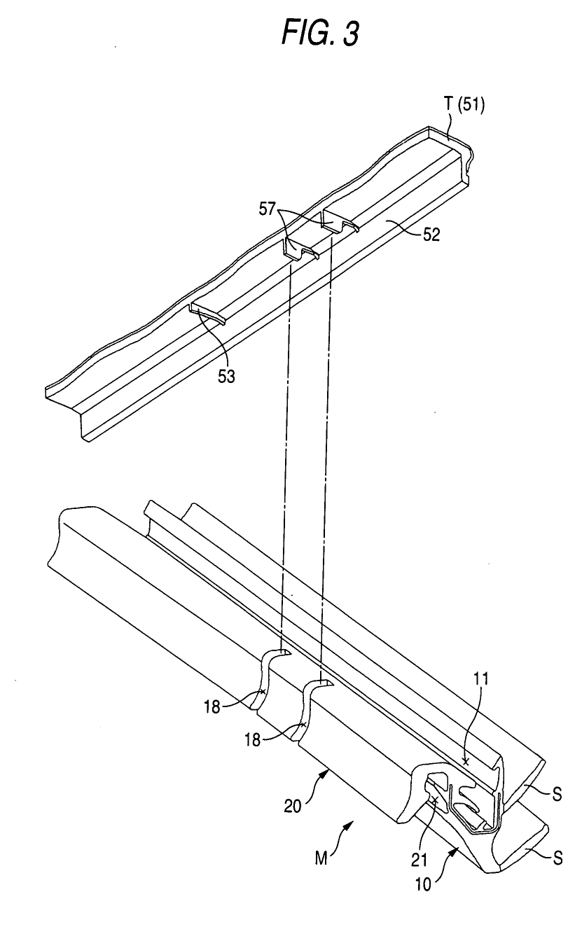

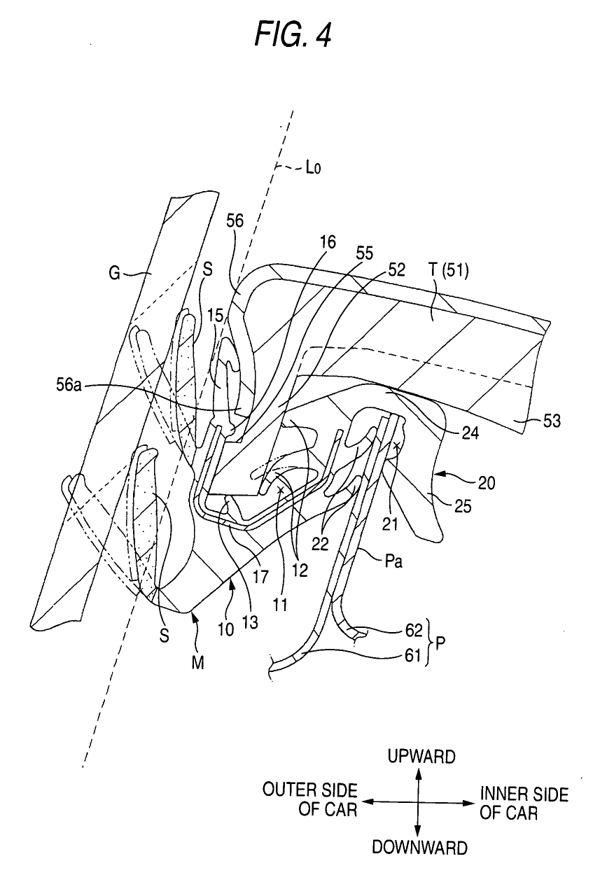

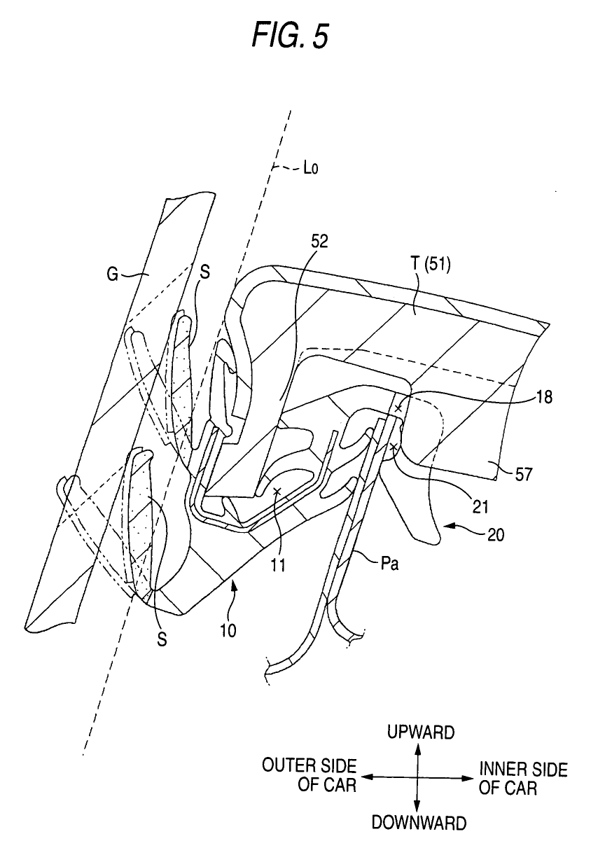

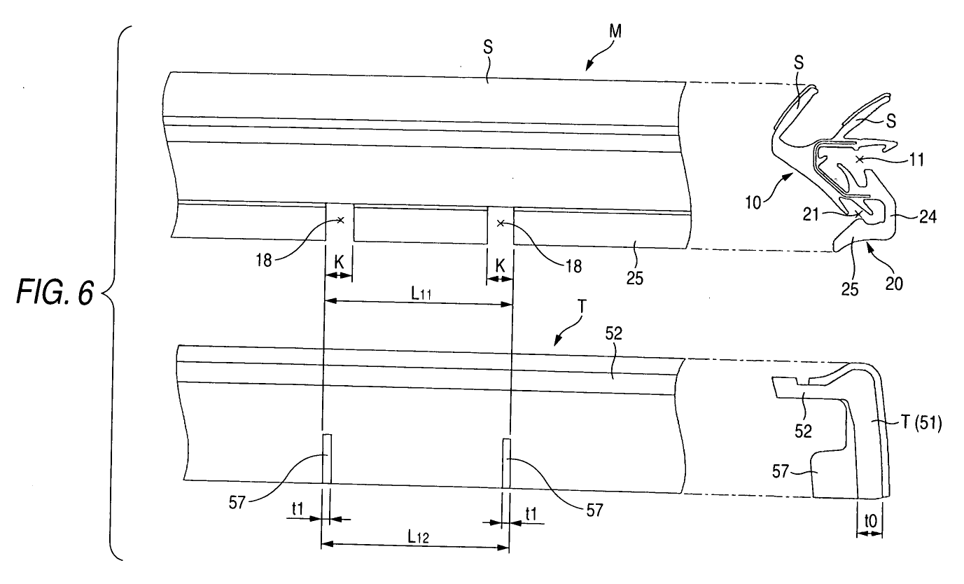

The present invention will be explained in more detail with reference to an embodiment hereinafter. FIG. 1 is a view showing a car right-side front door D to which a belt molding M according to the present invention is fitted when viewed from the inner side. FIG. 2 is a cross sectional view showing the separated state of the belt molding M and a trim board T. FIG. 3 is a perspective view showing a part of upper end portions of the belt molding M and the trim board T on their rear end sides respectively. FIG. 4 is an enlarged sectional view taken along an X₁—X₁ line in FIG. 1. FIG. 5 is an enlarged sectional view taken along an X₂—X₂ line in FIG. 1. FIG. 6 is a view showing mainly a relationship between a width (K) of a positioning slit 18 the belt molding M and a thickness (t₁) of a positioning rib 57 of the trim board T.

At first, a portion of a window opening B provided to the front door D of a car will be explained, and then the belt molding M fitted along a car-inner side opening edge of the window opening B in the fore-and-aft direction of a car body will be explained hereunder. In FIG. 1, the front door D that is opened/closed via a hinge comprises a door inner panel P (see FIG. 4 and FIG. 5) and a door outer panel (not shown). A glass-run channel (not shown) for guiding a lifting-up-and-down motion of a windowpane G is provided to the inside of a window frame 41, whose overall shape is an almost inverse U-shape, and a portion that is extended downward from the window frame 41. An elevating window W is constructed in such a manner that, when the windowpane G moves up and down along the guidance of the glass-run channel, the window opening B is completely or partially closed or is completely opened. An inside of the door inner panel P is covered with the trim board T, which is fitted to the door inner panel P by clips (not shown), etc., and is exposed to the interior side. An armrest 42 is fitted to the inner-side surface that is exposed to the interior side of the trim board T. In this case, in FIG. 1, 43 denotes a doorknob that is used to open the door from the interior side, and 44 denotes a side-mirror fitting hole.

Also, in FIG. 2, the trim board T is injection molded using ABS resin, PP resin, or the like, which is hard and has a rigidity, to have an almost planar shape as a whole. The trim board T is fitted on the interior side at a position that is lower than a lower edge of the window opening B. A downward flange portion 52 protruded downwardly is provided integrally to the portion that is positioned slightly toward the interior side rather than a car-outer side end 51a of an upper covering portion 51 provided to a top end of the trim board T. Because the downward flange portion 52 is provided to the above position, a distance (L₁) between an inner surface of the windowpane G and the downward flange portion 52 becomes larger than a distance (L₂) between the inner surface of the windowpane G and a car-outer side end of the trim board T (precisely, a car-outer side end of the upper covering portion 51) (see FIG. 2). As a result, this structure can assure sufficiently a margin of elastic deformation of a sealing lip S constituting the belt molding M and described later.

Also, as shown in FIG. 3, FIG. 5 and FIG. 6, a plurality of contact ribs 53 are provided integrally at a predetermined interval to a back surface of the upper covering portion 51 of the trim board T along the longitudinal direction of the car body so as to project downward in their fitting state. Also, a car-inner side side surface of the downward flange portion 52 of the trim board T is formed like a planar shape. However, a car-outer side side surface of the downward flange portion 52 is formed such that only a predetermined-length portion from its lower end constitutes a contact surface 54 that contacts to an inner wall surface of an upward opening groove 11 formed on the belt molding M and described later. A stepped portion 55 is formed on an upper portion than the contact surface 54 to have a structure that is inserted into a part of the belt molding M. A surface of the trim board T is covered with a cloth (skin material) 56 made of fabric, or the like. An end 56a of the cloth 56 on the car-outer side comes almost up to the stepped portion 55 on the car-outer side side surface of the downward flange portion 52. In this case, only a part of the contact ribs 53 is shown in FIG. 3.

Also, as shown in FIG. 4 and FIG. 5, the trim board T and the door inner panel P are arranged on the lower side than the lower edge of the window opening B of the front door D, and also arranged such that an upper-edge flange portion Pa of the door inner panel P is positioned directly under the upper covering portion 51 in the state that the trim board T is fitted to the car-inner side. Also, the door inner panel P includes a door inner panel main body 62 and a reinforcing plate 61 that is arranged on the outside of the main body. Both members 61, 62 are formed like a flat plate at the upper-edge flange portion Pa and are jointed together by the welding, or the like.

Then, the belt molding M fitted to the downward flange portion 52 of the trim board T and the upper-edge flange portion Pa of the door inner panel P will be explained with reference to FIG. 2 to FIG. 6 here under. This belt molding M includes a car-outer side fitting portion 10 having the upward opening groove 11 into which the downward flange portion 52 of the trim board T is inserted, and a car-inner side fitting portion 20 having a downward opening groove 21 into which the upper-edge flange portion Pa of the door inner panel P is inserted. Two sealing lips S is formed integrally on a car-outer side side portion of the car-outer side fitting portion 10. The two sealing lips S are separately disposed upward and downward and direct obliquely upward. Therefore, integrated portions of the car-outer side fitting portion 10 and the car-inner side fitting portion 20 constitute the “fitting portion”, which is fitted to the door member as a whole, and its cross sectional shape constitutes an almost laterally-turned S-shape.

In other words, a pair of gripping lips 12, 12 that can be elastically deformed are formed integrally over a car-inner side inner wall surface of the upward opening groove 11 formed in the car-outer side fitting portion 10 so as to project slightly toward the bottom side of the upward opening groove 11 (so as to incline slightly downwardly) Also, a holding lip 13 that can also be elastically deformed is formed integrally on a bottom surface of the upward opening groove 11 in such a fashion that the lip is projected to direct slightly to the car-outer side inner wall surface side. A cloth pressing lip 15 that can be elastically deformed is provided to an upper end portion of a car-outer side wall portion 14 (see FIG. 2) constituting the upward opening groove 11 of the car-outer side fitting portion 10 so as to extend upwardly. A projected latching stripe 16 that prevents the coming-off of the downward flange portion 52 of the trim board T, which is inserted into the upward opening groove 11 of the car-outer side fitting portion 10, is provided continuously to a connection portion between the car-outer side wall portion 14 and the cloth pressing lip 15 along the longitudinal direction. In this embodiment, a core member 17 that is formed by bending a metal strip to have an almost U-shaped sectional shape is embedded in the car-outer side fitting portion 10 to achieve prevention of the overall elongation and shrinkage and application of the rigidity. In this case, it is preferable that the core member should be formed like the laterally-turned S-shape similar to the fitting portion from a viewpoint of the application of the rigidity.

Also, a pair of gripping lips 22, 22 that can be elastically deformed are formed integrally on the car-outer side inner wall surface of the downward opening groove 21 of the car-inner side fitting portion 20 to direct obliquely upwardly. A car-outer side wall portion 23 of the car-inner side fitting portion 20 is also used as the car-inner side wall portion of the car-outer side fitting portion 10. A part of the core member 17 is embedded in the car-outer side wall portion 23 to enhance the rigidity. In this case, the core member may also be buried in an upper wall portion 24 and a car-inner side wall portion 25. The car-inner side wall portion 25 constituting the car-inner side fitting portion 20 is formed to incline such that the opening side of the downward opening groove 21 is expanded wider, and is formed like a lip as a whole.

Also, the pair of sealing lips S is sealing portions deforming elastically to come into elastic-contact with the inner surface of the windowpane G. Thus, the pair of sealing lips can prevent the water and the dust from getting inside of the car. The back surface side of the sealing lip S comes into elastic-contact with the inner surface of the windowpane G. The back surface side of the sealing lip S is provided with flocked fabrics made of nylon pile or the like.

The belt molding M is extrusion molded from the material having a rubber elasticity so as to extend longitudinally. The core member 17 is extruded together in the embedded state. As the material having a rubber elasticity, rubber material such as EPDM, etc., or thermoplastic elastomer (TPE) maybe listed as the preferred one. In addition, different materials are effectively used in the belt molding M for the material of the car-outer side fitting portion 10 and the car-inner side fitting portion 20 and for the material of the sealing lips S, respectively. In other words, it is preferable that the sealing lips S are formed out of the material soft and good in flexibility, while it is preferable to form the fitting portions 10, 20 out of the material harder than the sealing lips S and good in rigidity. When such materials are selected, the fitting characteristic of the belt molding M to the door member is stabilized and also the sealing lips S can contact to the inner surface of the windowpane G without fail, so that the sealing property between the windowpane G and the sealing lip S can be enhanced. As the concrete materials, respective fitting portions 10, 20 are formed out of the rubber or TPE, each being relatively hard and having rigidity greater than the sealing lips S. The sealing lips S are formed out of the soft rubber or the soft TPE material, each softer than the material of the fitting portions 10, 20 and good in elasticity. Then, two portions formed out of different materials as above (fitting portions 10 and the sealing lips S) are melted and jointed and then molded integrally by the co-extrusion molding. Thus, the fitting portions 10, 20 are obtained

Also, as shown in FIG. 1, FIG. 3, FIG. 5 and FIG. 6 respectively, a pair of positioning slits 18 are formed in portions, which are close to a rear end of the car-inner side fitting portion 20 constituting the belt molding M in the fitted state, at a predetermined interval along the longitudinal direction so as to cross partially the car-inner side fitting portion 20. More particularly, in the cross sectional view of the car-inner side fitting portion 20 of the belt molding M, a pair of positioning slits 18 are formed in the full area of the car-inner side wall portion 25 constituting the car-inner side fitting portion 20 and the almost half area of the upper wall portion 24. Apart from the contact ribs 53, a pair of positioning ribs 57 are formed on portions of the back surface of the upper covering portion 51 of the trim board T, corresponding to the pair of positioning slits 18 of the belt molding M. In this manner, in case the positioning slits 18 are provided to the portions that are close to the rear end of the belt molding M, it is preferable that the rear end surface of the belt molding M is brought into contact with the glass-run as closely as possible from a viewpoint of the whistling sound and the sound insulation property. Therefore, if the positioning slits 18 are provided on the rear end side of the belt molding M, a positional displacement is hard to occur and thus such structure is preferable.

Also, as shown in FIG. 6, a width (K) of the positioning slits 18 is larger than a thickness (t₁) of the positioning ribs 57, and also a distance (L₁₁) between outer-side surfaces of a pair of positioning slits 18 is equal to a distance (L₁₂) between outer-side surfaces of a pair of positioning ribs 57 (L₁₁=L₁₂).

According to this dimensional configuration, when the belt molding M is fitted to the downward flange portion 52 of the trim board T by inserting the downward flange portion 52 of the trim board T into the upward opening groove 11 of the belt molding M, the positioning ribs 57 are inserted into the positioning slits 18 respectively in the state that the outer-side side surfaces of a pair of positioning ribs 57 of the trim board T come into contact with the outer-side groove surfaces of a pair of positioning slits 18 of the belt molding M, so that the belt molding M can be fitted to the trim board T in the state that the positioning in the fore-and-aft direction of the door is decided. Since the width (K) of the positioning slits 18 formed in the belt molding M and the thickness (t₁) of the positioning ribs 57 formed in the trim board T are set to the above dimensional relation, a slit making work is facilitated because of the large width when the positioning slits 18 are formed in the belt molding M, and also the assembling operation (fitting operation) is also facilitated when the belt molding M is fitted to the trim board T.

In this case, in the above embodiment, if a distance between inner-side groove surfaces of a pair of positioning slits 18 and a distance between inner-side surfaces of a pair of positioning ribs 57 are set equal mutually, it is possible to implement such a relation that the inner-side surfaces of a pair of positioning ribs 57 contact to the inner-side groove surfaces of a pair of positioning slits 18 respectively and also the positioning ribs 57 of the trim board T are inserted into the positioning slits 18 of the belt molding M respectively.

The thickness (t₁) of the positioning ribs 57 and a thickness (t₀) of normal portions of the trim board T have a relationship of [t₁=(⅓ to ⅔)t₀]. In this manner, if the thickness (t₁) of the positioning ribs 57 is set smaller than the thickness (t₀) of normal portions of the trim board T, there is such an advantage that, when the trim board T is to be molded by the injection molding, generation of the “sink mark” on a surface of the trim board T due to a difference in an amount of shrinkage in the resin cooling can be prevented. Also, if the thickness of the contact ribs 53 and the thickness (t₀) of normal portions of the trim board T are set to the above relationship, generation of the “sink” that is generated on the surface side of the contact ribs 53 in the trim board T can be prevented.

Then, the belt molding M having the above structure is fitted to the trim board T constituting the door panel of the front door D. There are two type fitting methods, and then any one of them is decided by studying advantages and disadvantages of these methods respectively. One fitting method is such a fitting method that first the belt molding M is fitted to the trim board T, and then the upper-edge flange portion Pa of the door inner panel P constituting the door panel is inserted into the downward opening groove 21 of the belt molding M that is fitted to the trim board T. The other fitting method is such a fitting method that first the belt molding M is fitted to the door inner panel P by inserting the upper-edge flange portion Pa of the door inner panel P constituting the door panel into the downward opening groove 21 of the belt molding M, and then the downward flange portion 52 of the trim board T is inserted into the upward opening groove 11 of the belt molding M. According to the former method, when the belt molding M is fitted to the trim board T, first the trim board T is turned out, and then the downward flange portion 52 of the trim board T can be inserted relatively into the upward opening groove 11 of the belt molding M from the back surface side of the trim board T while mating positions of the positioning slits 18 of the belt molding M with the positioning ribs 57 of the trim board T. Therefore, there can be achieved such an advantage that the fitting operation of the belt molding M to the trim board T is made easy.

Then, according to any fitting method, in the state that the belt molding M is fitted to the trim board T constituting the inside of the window opening B of the door panel, as shown in FIG. 4 and FIG. 5, the downward flange portion 52 of the trim board T can be inserted into the upward opening groove 11 of the belt molding M and also the upper-edge flange portion Pa of the door inner panel P can be inserted into the downward opening groove 21 of the belt molding M. Also, a pair of positioning ribs 57 of the trim board T are put into a pair of positioning slits 18 of the belt molding M respectively in the above state to position the belt molding M with respect to the trim board T in the longitudinal direction, as described above.

In the state that the belt molding M is fitted to the downward flange portion 52 of the trim board T, a pair of pushing lips 12 are brought into elastic-contact with the car-inner side side surface of the downward flange portion 52 and also the holding lip 13 is brought into elastic-contact with the lower end surface of the downward flange portion 52, so that the contact surface 54 formed on the car-outer side side surface of the downward flange portion 52 is caused to contact to the car-outer side inner side surface of the upward opening groove 11 of the belt molding M. Also, since the stepped portion 55 being provided to the car-outer side side surface of the downward flange portion 52 is arranged lower than the projected latching stripe 16 that is formed on the car-outer side inner side surface of the upward opening groove 11 of the belt molding M, the coming-off of the downward flange portion 52 from the upward opening groove 11 of the belt molding M can be prevented. Also, the cloth pressing lip 15 being provided to the car-outer side fitting portion 10 of the belt molding M is brought into elastic-contact with the portion being positioned slightly higher than the end 56a of the cloth 56, which is spread over a surface of the trim board T, to prevent the peeling-off of the cloth 56.

In contrast, in the portion of the car-inner side fitting portion 20 of the belt molding M, a pair of pushing lips 22 being provided to the car-outer side inner side surface of the downward opening groove 21 are brought into elastic-contact with the car-outer side side surface of the upper-edge flange portion Pa of the door inner panel P, and then the upper-edge flange portion Pa is held between the pushing lips 22 and the car-inner side wall portion 25. Also, as shown in FIG. 4, a plurality of contact ribs 53 formed on the back surface of the upper covering portion 51 of the trim board T contact to the upper wall portion 24 of the car-inner side fitting portion 20, whereby an insertion length of the downward flange portion 52 of the trim board T into the upward opening groove 11 of the car-outer side fitting portion 10 of the belt molding M is defined. Then, the upper end surface of the upper-edge flange portion Pa of the door inner panel P comes into contact with an inner surface of the upper wall portion 24 constituting the car-inner side fitting portion 20 of the belt molding M.

Accordingly, the downward flange portion 52 of the trim board T is inserted into the upward opening groove 11 of the car-outer side fitting portion 10 of the belt molding M, and also the upper-edge flange portion Pa of the door inner panel P is inserted into the downward opening groove 21 of the car-inner side fitting portion 20. As a result, the downward flange portion 52 and the upper-edge flange portion Pa are held firmly by pushing operations of the pushing lips 12, 22 respectively. Also, a pair of sealing lips S formed integrally on the car-outer side side surface of the car-outer side fitting portion 10 of the belt molding M are elastically deformed to come into elastic-contact with the inner surface of the windowpane G, and contact stably to the inner surface at the time of elevating the windowpane G. Therefore, a pair of sealing lips S can prevent the water and the dust from entering into the inside of the car from the outside of the car.

In this way, the belt molding M is fitted to two different fitted portions (the downward flange portion 52 and the upper-edge flange portion Pa) of the door panel. Therefore, even if a force of causing the belt molding M to move vertically (exactly, the elevating direction of the windowpane G) acts because of the sliding resistance to the sealing lips S at the time of elevating the windowpane G, any one of above two different fitted portions can receive this force and thus the movement of the belt molding M can be prevented. Also, because of the same reason, displacement of the fitted position of the belt molding M along the car inside-outside direction does not occur (or is hard to occur) in contrast to the case where the belt molding M is fitted to one fitted portion (the downward flange portion 52) of the door panel. As a result, the fitting state of the belt molding M can be stabilized in structure.

Also, as described above, the downward flange portion 52 being formed integrally on the back surface of the upper covering portion 51 on the upper end of the trim board T is formed as the portion that is retreated slightly from the car-outer side end (end edge) of the trim board T (exactly, the car-outer side end of the upper covering portion 51) to the car-inner side. Therefore, the distance (L₁) between the inner surface of the windowpane G and the downward flange portion 52 becomes larger than the distance (L₂) between the inner surface of the windowpane G and the car-outer side end of the trim board T (precisely, the car-outer side end of the upper covering portion 51) (see FIG. 2). As a result, even if the distance (L₂) between the inner surface of the windowpane G and the car-outer side end of the trim board T is set narrowly to such extent that fingers of the infant, etc. can be prevented from being pinched between them, the distance (L₁) between the inner surface of the windowpane G and the downward flange portion 52 of the trim board T is still kept longer than the distance (L₂). Hence, an alignment space of a pair of sealing lips S (a projection length of the sealing lips S) constituting the belt molding M can be assured sufficiently and also a margin of elastic deformation of the sealing lips S can be assured sufficiently. Accordingly, if the distance (L₂) between the inner surface of the windowpane G and the car-outer side end of the trim board T is shortened (narrowed), reduction in a sealing force of the sealing lips S against the windowpane G can be prevented. Also, as the result of the event that the distance (L₂) between the inner surface of the windowpane G and the car-outer side end of the trim board T is shortened, a clearance generated in this portion along the width direction of the car body is narrowed and also the ornamental property (fine sight) can be enhanced at the same time. In this case, in FIG. 4 and FIG. 5, a broken line Lₒ indicates a position of the car-outer side end of the trim board T.

In the above embodiment, the belt molding M has two fitting portions 10, 20 on the car-outer side and the car-inner side, and this belt molding M is fitted to two portions of the downward flange portion 52 of the trim board T and the upper-edge flange portion Pa of the door inner panel P. Thus, as described above, the fitting stability of this belt molding M can be increased much more. However, since the belt molding M having such a structure that only the car-outer side fitting portion 10 having the upward opening groove 11 is provided can also achieve the basic advantages of the present invention, such belt molding M is contained in the technical scope of the present invention.

In the above embodiment, the example in which the present invention is applied to the belt molding M constituting the elevating window W that is provided to the front door D of the vehicle is explained. It is a matter of course that the present invention can be applied to the belt molding constituting other elevating window of the vehicle.

According to the invention, the fitting portion is provided with the upward opening groove fittable with the downward flange portion of the trim board fitted to the car-inner side of the elevating window. The downward flange portion projects downward from the position slightly shifted in a car-inner direction from the car-outer side end of the trim board. In the state that the trim board is fitted to the belt molding by inserting the downward flange portion of the trim board into the upward opening groove, a clearance between the end edge of the trim board as the car-inner side door member and the inner surface of the windowpane can be reduced and in addition a sufficient alignment space of the sealing lips can be assured between the downward flange portion and the inner surface of the windowpane. As a result, a clearance between the end edge of the trim board and the inner surface of the windowpane can be kept small, and therefore such a peril that the fingers of the infant, etc. are caught in this clearance can be eliminated, the ornamental property can be improved, and a substantial projection length of the sealing lips can be lengthened. As a consequence, a margin of elastic deformation of the sealing lips with respect to the windowpane can be assured sufficiently, and the sliding resistance is not increased without reduction in the sealing performance to the elevating windowpane.

What is claimed is:

1. A vehicle inner belt molding to be fitted along an interior of an opening edge of an elevating window in a vehicle, wherein the vehicle has a door inner panel and a trim board being attached to the door inner panel and having a downward flange portion protruding from a position interior of an outer end of the trim board, the vehicle inner belt molding comprising:
a fitting portion to be attached to a vehicle body; and
a sealing lip formed integrally with an exterior side of the fitting portion to be in elastic contact with an inner surface of a windowpane of the elevating window;
wherein the fitting portion has an upward opening groove fittable with the downward flange portion.

2. The vehicle inner belt molding according to claim 1,
wherein the fitting portion includes an outer fitting portion having the upward opening groove and an inner fitting portion to be positioned interior of the outer fitting portion; and
the inner fitting portion has a downward opening groove for receiving an upper-edge flange portion of the door inner panel.

3. The vehicle inner belt molding according to claim 1,
wherein the upward opening groove is provided with at least one gripping lip for gripping the downward flange portion to prevent the downward flange portion from coming-off.

4. The vehicle inner belt molding according to claim 2,
wherein the upward opening groove is provided with at least one gripping lip for gripping the downward flange portion to prevent the downward flange portion from coming-off; and
the downward opening groove is provided with at least one gripping lip for gripping the upper-edge flange portion to prevent the upper-edge flange portion from coming-off.

5. The vehicle inner belt molding according to claim 1, further comprising: a cloth pressing piece protruding upward from the exterior side of the fitting portion;
wherein the cloth pressing piece presses an end portion of a cloth covering a surface of the trim board when the downward flange portion is fitted into the upward opening groove.

6. The vehicle inner belt molding according to claim 1,
wherein the fitting portion has a positioning slit partially crossing therethrough; and
the positioning slit is engageable with a positioning rib projecting downward from a back surface of the trim board.

7. The vehicle inner belt molding according to claim 6,
wherein a thickness of the positioning rib is smaller than a width of the positioning slits.

8. The vehicle inner belt molding according to claim 7, wherein the positioning slit includes at least two of positioning slits arranged at a predetermined interval in a longitudinal direction of the fitting portion;
the positioning rib includes at least two of positioning ribs to be fitted into the positioning slits; and
the two of positioning slits are formed so that the opposing surfaces of the two of positioning ribs are brought into contact with inner-side surfaces of the two of positioning slits when the two of positioning ribs are fitted into the two of positioning slits.

9. The vehicle inner belt molding according to claim 7,
wherein the positioning slit includes at least two of positioning slits arranged at a predetermined interval in a longitudinal direction of the fitting portion;
the positioning rib includes at least two of positioning slits to be fitted into the two of positioning slits; and
the two of positioning slits are formed so that the outer-side surfaces of the two of positioning ribs are brought into contact with outer-side surfaces of the two of adjacent positioning slits when the two of positioning ribs are fitted into the two of positioning slits.

10. The vehicle inner belt molding according to claim 6, further comprising: a core member embedded in the fitting portion in the longitudinal direction thereof, the core member made of a plate-like material having an expansion resistance and a rigidity both larger than those of the fitting portion;
wherein the core member has a cross sectional shape substantially similar to that of at least a part of the fitting portion.

11. The vehicle inner belt molding according to claim 1,
wherein the fitting portion is made of thermoplastic elastomer material.

12. The vehicle inner belt molding according to claim 1,
wherein the sealing lip is made of a material which is capable of fusion-bonding to the fitting portion and which is softer and more elastic than the fitting portion.

13. A sealing structure of an elevating window in a vehicle, comprising:
a vehicle inner belt molding to be fitted along an interior side of an opening edge of the elevating window, the vehicle inner belt molding including a fitting portion to be attached to a vehicle body and a sealing lip formed integrally with an exterior side of the fitting portion to be in elastic contact with an inner surface of a window pane of the elevating window; and
a trim board disposed inside of the elevating window, the trim board having a downward flange portion protruding from a position interior of an outer end thereof;
wherein the fitting portion has an upward opening groove fittable with the downward flange portion; and
the vehicle inner belt molding is attached to the trim board by inserting the downward flange portion into the upward opening groove.

14. The sealing structure according to claim 13,
wherein the fitting portion includes an outer fitting portion having the upward opening groove and an inner fitting portion to be positioned interior of the outer fitting portion;
the outer fitting portion has a positioning slit partially crossing therethrough;
the trim board has a positioning rib projecting downward from a back surface thereof; and
the inner belt molding is attached to the downward flange portion while being positioned in a longitudinal direction by inserting the positioning rib into the positioning slits.
